(19) United States
(12) Patent Application Publication
(10) Pub. No.: US 2004/0222200 A1
(43) Pub. Date: Nov. 11, 2004

(54) Brazed copper heat exchangers and process for manufacturing them by welding

(76) Inventors: Christian Bonnet, Puiseux-Pontoise (FR); Jean-Marie Fortain, Osny (FR); Marc Wagner, Saint Maur (FR)

Correspondence Address: Linda K. Russell, Air Liquide, Suite 1800, 2700 Post Oak Blvd., Houston, TX, 77056, US

(21) Appl. No.: 10/628,153

(22) Filed: Jul. 28, 2003

(30) Foreign Application Priority Data
Jul. 30, 2002 (FR) 0209658

(51) Int. Cl. B23K 15/00; B23P 15/26

(52) U.S. Cl. 219/121.14; 29/890.054

(57) ABSTRACT

The invention relates to a process for the arc welding of at least one metal workpiece (1) to a matrix (2) comprising at least one brazed zone (3), the braze of which contains copper and phosphorus, in which (a) at least one layer (5, 6, 7) of an alloy containing copper and more than 1% tin by weight is deposited on at least one part of the brazed zone (3) and (b) the metal workpiece (1) is welded to the said at least one layer (5, 6, 7) of copper/tin alloy deposited in step (a). Process for manufacturing a brazed copper heat exchanger, in which such a welding process is carried out. Exchangers thus obtained and their use in the cryogenic separation of gases, particularly air gases, in a cryogenic separation unit.

The invention relates to a process for welding brazed copper heat exchangers, to a process for manufacturing heat exchangers by welding, to the exchangers obtained by such a process and to their use for the separation of gases, especially air.

Copper heat exchangers are usually manufactured firstly by stacking plates and fins, that are brazed together to form a matrix, and then by adding one or more fluid collecting containers serving for collecting and distributing the fluids treated in the equipment.

The fluid collecting container(s), also called headers, are attached and fastened in a known manner to the brazed matrix of the exchanger by welding.

In the general case of copper/copper bonding by welding, it is common practice to use a copper alloy (copper/nickel alloy or copper/aluminium alloy, etc.) as filler product as it is easier to use than pure copper.

However, in the particular case of joining one or more headers to a brazed matrix during the manufacture of a heat exchanger, the weld joining the fluid header to the matrix necessarily crosses the braze-filled interstices that connect the constituent plates and fins of this part of the exchange together.

Currently, two types of brazing alloy are used to braze copper, namely copper/silver alloys, which are very expensive, and copper/phosphorus alloys, which are very much less expensive but generally contain an amount of phosphorus between about 5% and about 8% by weight. Adding silver or phosphorus in fact significantly lowers the melting point of the alloy with respect to pure copper, typically by several hundred degrees Celsius, this being essential in order to be able to carry out a brazing operation.

However, several problems arise when the matrix formed from brazed plates and fins has been manufactured using a braze with a copper alloy to which phosphorus has been added.

This is because, when welding the brazed copper matrix, for example to a copper collecting vessel, the region of brazing of the matrix located in the joint plane that has to be welded will be mixed with the welding alloy used for producing the welded joint between this brazed matrix and the wall of the container that has to be welded thereto.

This may then result in vapourization of the phosphorus, deriving a risk of porosity as the temperature of the weld pool is much higher than the brazing temperature, and above all embrittlement of the welded joint thus produced using conventional filler products, since the solubility of phosphorus in the alloys normally used for welding is very low. This results, during solidification of the joint, in substantial phosphorus segregation and, as a consequence, the formation of brittle zones very rich in phosphorus.

This may then lead to welded joint cracking phenomena and leaks or other sealing problems may then occur on the exchanger thus manufactured.

The object of the invention is therefore to propose an improved welding process applicable to the manufacture of brazed copper heat exchangers that makes it possible to alleviate the abovementioned problems, and also improved exchangers obtained by this process that do not have leakage problems or problems of poor sealing.

In other words, the problem posed is to be able to weld copper parts of heat exchangers effectively, without forming phosphorus-rich brittle zones, and therefore to provide a process for welding heat exchangers that results in the production of exchangers of greater strength than exchangers whose constituent underlying parts were welded by using conventional processes.

The invention therefore relates to a process for the arc welding of at least one metal workpiece to a matrix comprising at least one brazed zone, the braze of which contains copper and phosphorus, in which:

(a) at least one layer of an alloy containing copper and more than 1% tin by weight is deposited on at least part of the brazed zone; and

(b) the metal workpiece is welded to the said at least one layer of copper/tin alloy deposited in step (a).

Within the context of the invention, the percentages (%) are percentages by weight.

Depending on the case, the process of the invention may include one or more of the following technical features:

the copper/tin alloy contains at least 1.05% tin, preferably at least 1.2% tin;

the copper/tin alloy contains less than 10% tin, preferably less than 6% tin;

the copper/tin alloy contains at least 80% copper, preferably at least 90% copper, by weight;

the copper/tin alloy contains less than 1% phosphorus by weight;

the copper/tin alloy contains from 2% to 8% tin, preferably around 3 to 6% tin, by weight;

in step (a), several layers based on a copper/tin alloy are deposited, these being at least partly superposed one with respect to another;

the deposition of at least one layer of copper/tin alloy of step (a) is carried out by (i) locally preheating the alloy zone to be coated and (ii) supplying and depositing, in the zone preheated in step (i) the copper/tin alloy melted by an electric arc;

the preheating of step (i) is carried out by using one or more electric arcs, preferably at least one arc generated by a TIG or plasma welding torch;

in step (ii), the alloy is supplied in the form of a wire of copper/tin alloy;

in step (ii), the electric arc for melting the meltable wire is generated by at least one MIG or TIG welding torch;

the brazed matrix furthermore contains at least one braze element chosen from SN, AG and ZN;

the copper/tin alloy constituting the layer or layers deposited in step (a) optionally contains at least one additional element chosen from silicon, manganese, iron and nickel;

the braze contains 3 to 10% phosphorus, 0 to 15% silver and 0 to 1% nickel;

the layer or layers deposited in step (a) contain less than 0.5% manganese, less than 0.5% silicon and less than 0.05% iron;

in step (b), the workpiece is welded by an MIG, TIG or plasma process, or a combination of these processes, preferably a pulsed MIG process;

the brazed matrix is supported by a stack of several plates separated by fins forming spacers between the said plates, the said fins and the said plates being brazed to one another so as to form the said brazed matrix;

the workpiece is a component of a fluid collecting and/or distributing container forming part of a heat exchanger, the said workpiece preferably being made of copper or stainless steel.

the layer deposited on the matrix has a width sufficient to allow a welded joint to be produced between the workpiece and the said layer without incorporating into the said joint additional elements coming from the brazed zone of the matrix.

The invention also relates to a process for manufacturing a brazed copper heat exchanger, in which the welding process according to the invention is used to weld at least one fluid collecting and distributing container, preferably made of copper, of the exchanger to a stack of plates separated by fins forming spacers between the said plates and supporting at least one brazed matrix.

The invention also relates to a copper heat exchanger comprising at least one fluid collecting and distributing container welded to a brazed matrix supported by a stack of several plates separated by fins forming spacers between the said plates, characterized in that the said container is welded to at least one layer of an alloy containing copper and more than 1% tin by weight, the said at least one copper/tin layer being deposited on the said brazed matrix.

According to another aspect, the invention also relates to a plant for separating fluids, particularly gas mixtures, comprising at least one exchanger according to the invention, preferably the said plant being a cryogenic air separation unit.

According to yet another aspect, the invention relates to a process for separating fluids, particularly gas mixtures, in which at least one heat exchanger according to the invention is used, the fluid preferably being air.

The invention is illustrated in the figures appended hereto.

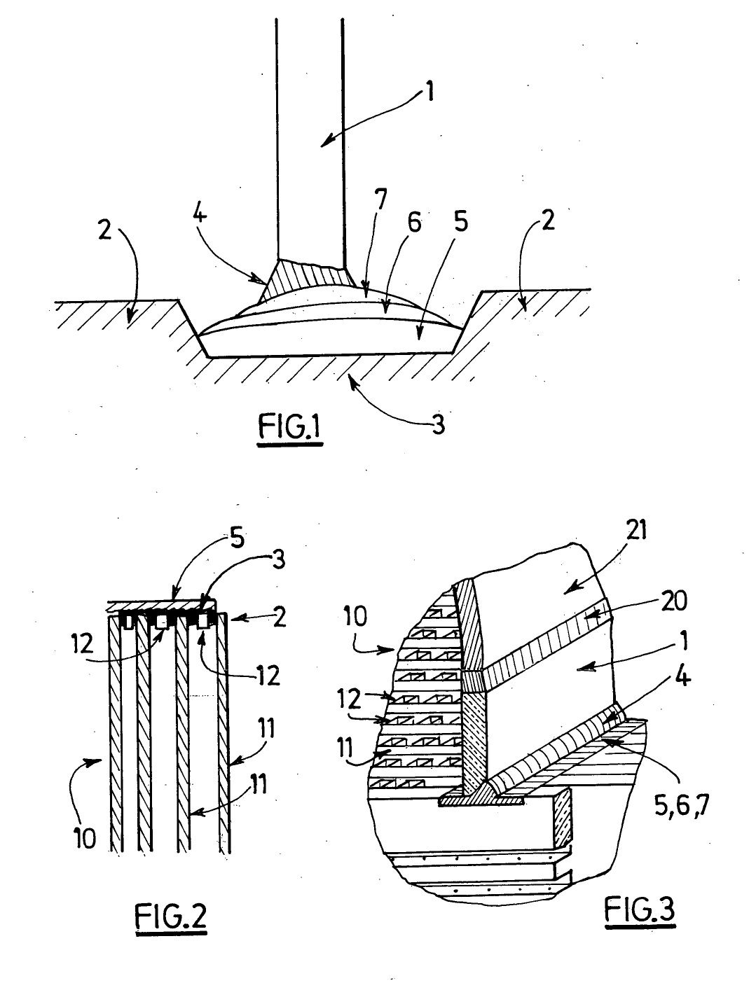

FIG. 1 shows the principle of the invention applicable to the welding of a workpiece 1, for example a fluid collecting and distributing container for a heat exchanger, to a brazed 3 matrix 2, such as the brazed matrix 2 of a heat exchanger formed by brazing a stack of plates 11 separated by fins 12 forming spacers, as shown in detail in FIG. 2.

To avoid the abovementioned problems of the weld 4 cracking, the workpiece 1 is not welded directly to the matrix 2 having the brazed zone 3 formed from a copper alloy generally containing less than 10% phosphorus and optionally other compounds, as is commonly done in the prior art.

This is because, by operating as in the prior art, it has been found that during welding of the header to the brazed matrix of an exchanger, a small thickness of the brazed exchanger (matrix) is melted by the molten welding material, and the braze is then mixed with the metal deposit (welded joint), but not uniformly throughout the deposit.

In the molten metal near the braze, local enrichment with the elements contained in the braze then occurs. Among these elements, the inventors of the present invention have demonstrated that phosphorus is the one that is the origin of the cracking problems arising in the prior art if the local phosphorus concentration exceeds the solubility limit in the “local alloy” resulting from the non-uniform mixing of the deposited metal, the copper of the exchanger and the braze.

According to the invention, to avoid this phosphorus-induced cracking problem, one or more superposed layers 5, 6, 7 of a copper/tin alloy, (containing more than 1% tin by weight) are firstly deposited on that face of the matrix 2 having the braze 3, so as to constitute a base to which the workpiece 1 is then welded; these superposed copper layers 5, 6, 7 covering the brazed surface 3 are called “buttering” layers.

In this way, the “buttering” layers 5, 6, 7, deposited on the surface on which the brazed interstices 3 of the matrix 2 terminate, constitute an isolating barrier that prevents any possible contamination of the welded joint 4 by resurgence of deleterious elements coming from the braze 3 during subsequent welding of the workpiece 1 to the buttering layers 5 to 7.

In fact, the copper layers 5 to 7 thus formed may accept a considerable amount of contaminants, as dilution, without substantially deteriorating thereby.

According to the invention, the workpiece 1 is therefore welded, along the welded joint 4, to the buttering layer or layers 5 to 7 deposited beforehand on the brazed matrix 3, and not directly to the brazed zone 3, as is conventionally done in the prior art.

However, a difficulty arises when welding copper with a copper filler product because the copper melts and solidifies at a fixed temperature and not within a temperature range like most alloys. Consequently, the weld pool is very difficult to handle for a welder and the beads obtained are generally poorly “wetted”, that is to say the sides of the bead are poorly connected to the base metal, and they often also exhibit bonding-type defects, that is to say the filler metal is “laid down” on the base metal without the latter melting.

Attempts may be made to overcome these problems by preheating the exchanger, but this operation is very difficult to control because, owing to the very high thermal conductivity of copper, the heat supplied in the welding zone very rapidly diffuses into the entire exchanger, which means that the entire heat exchanger has to be heated to the preheat temperature, for example to 300° C. It may therefore be appreciated that to proceed in this way is lengthy and expensive, and may result in defects in the buttering, as this causes oxidation of the surface on which it is desired to deposit the weld beads.

To avoid all these drawbacks, trials of implementing the invention have shown that it is possible to dispense with preheating the zone to be welded if the MIG torch is preceded, a few centimetres ahead, by an electric arc, for example an deconfined plasma or TIG arc, or several arcs, placed transversely or longitudinally with respect to the welding direction. This provides very local but effective preheating, since the heat thus provided by the preheating arc(s) does not have time to diffuse significantly into the mass of the exchanger, because of the short time that elapses between the preheating pass with the plasma or TIG arc(s) and the pass by the MIG torch that deposits the filler metal.

Another satisfactory solution consists in using a hybrid plasma/MIG torch characterized by a plasma arc that surrounds the filler wire and the MIG arc.

When it is desired to minimize contamination, several welding passes are advantageous as they allow several superposed “buttering” layers 5 to 7 to be obtained.

Of course, the buttering layers 5 to 7 have a sufficient width and will be made with a copper alloy containing more than 1% tin, preferably around 3 to 6% tin, for which the solubility limit of phosphorus is again high enough at the solidification temperature, for example a solubility of 0.5 to 1%, so that phosphorus coming from the braze and introduced into the buttering layer 5 is able to be diluted sufficiently to avoid the formation of cracks and an additional weld 4 can be produced without risking the integrity of the structure.

This process is particularly well suited to the manufacture of brazed heat exchangers that can be used for separating gases, in particular cryogenically within cryogenic distillation columns.

The detailed structure of a heat exchanger will not be described hereinbelow as it is well known in the industry and can also be seen in particular on the Internet site www.alpema.org or described in “The Standards of the Brazed Aluminium Plate-Fin Heat Exchanger Manufacturers Association”, ALPIMA, Second Edition, 2000.

The detailed structure of the brazed zone of a copper exchanger 10 of this type, seen in cross section, is indicated schematically in FIGS. 2 and 3 which show that it comprises a stack of metal plates or sheets 11 separated from one another by fins 12 forming spacers between the said plates. The said fins 12 are brazed at the ends of the plates 11 so as to form there a brazed 3 matrix 2 (see also FIG. 1) to which one or more structures or containers 1 serving to collect and distribute the fluids in the exchanger 10 must be welded.

According to the invention, the “buttering” layers 5 to 7 are produced on the external surface of this brazed zone 3 of the matrix 2 of the exchanger 10, as explained above in relation to FIG. 1, before the said fluid collecting and distributing container or structure is welded to this or these “buttering” layers 5 to 7 that may contain alloying elements or inevitable impurities.

As explained above, to carry out the “buttering” pass or passes, the zone to be coated firstly undergoes localized preheating and then a molten Cu/Sn alloy is deposited in this preheated zone, the said Cu/Sn alloy being supplied in the form of a meltable wire, which is melted by using an electric arc, in particular by means of an MIG torch. The MIG process is preferred as this welding process generates greater movement in the liquid pool of molten metal than the TIG process, thereby preventing any localized concentration of certain deleterious elements, such as phosphorus, particularly in the zones of the “buttering” bead 5 where it crosses the braze.

During trials to implement the invention, it was found that an alloy of the Cu-Sn6P type, that is to say containing about 6% tin, less than 1% phosphorus and copper for the rest (up to 100% by weight), optionally excluding inevitable impurities, can accept a relatively large amount of phosphorus as dilution.

In addition, this Cu-Sn6P alloy has a melting point below that of pure copper and therefore closer to that of the brazing alloy (900° C. solidus temperature and 1050° C. liquidus temperature, compared with 1083° C. of pure copper).

In addition, this alloy leads to improved “wetting” and to effected penetration of the molten alloy into the gaps in the brazed joints.

The thermal conductivity of this Cu-Sn6P alloy is 57 W/m.K at room temperature, as opposed to 380 W/m.K for pure copper. This alloy is therefore easier to weld than pure copper and can therefore be deposited by an MIG welding process but also a TIG welding process with moderate preheating.

Moreover, this alloy allows the buttering to be carried out, but its properties also allow it to be used to produce the closure weld on the box. This alloy also has very good mechanical properties at cryogenic temperatures.

This alloy is standardized in AWS under the name Er Cu Sn-A and according to BS2901, part 3, grade C11.

However, to weld the workpiece (header container) to the copper-coated brazed zone, it is also possible to use an arc welding torch, such as an MIG (Metal Inert Gas) torch, a TIG (Tungsten Inert Gas) torch or a plasma torch, or combinations of such torches, for example a plasma-MIG torch or MIG-TIG torches, and it is possible as a complement to supply a filler product of the copper/nickel or copper/aluminium type or, when it is desired to produce a bond between the copper-covered zone and a stainless steel workpiece, such as a fluid header, it is possible to provide the use of other filler products of the nickel or nickel-alloy type. In fact, in the case of the manufacture of a heat exchanger, it is possible to choose either to weld a stainless steel fluid header directly to the copper layers 5, 6, 7, or to weld (via a welded joint 20) the stainless steel fluid header 21 to a copper intermediate workpiece 1 which is itself welded to the copper layers 5, 6, 7 as shown in FIG. 3.

The welding process of the invention is particularly well suited to the manufacture of brazed heat exchangers that can be used for separating air gases, in particular cryogenically within cryogenic distillation columns, since these exchangers will be more resistant to cracking problems than conventional exchangers.

1-17. (canceled).

18. A process for arc welding, which comprises:
(a) at least one metal workpiece (1);
(b) a matrix (2) consisting of at least one brazed zone (3); and
(c) a braze that contains copper and phosphorus,
wherein said process comprises the steps of:
(i) depositing at least one layer (5, 6, 7) of an alloy containing copper and tin on at least part of the brazed zone (3); and
(ii) welding the metal workpiece (1) to at least one copper/tin alloy layer (5, 6, 7).

19. The process according to claim 18, wherein said copper/tin alloy comprises at least about 1.0% tin by weight.

20. The process according to claim 19, wherein said copper/tin alloy comprises at least about 1.05% tin by weight.

21. The process according to claim 20, wherein said copper/tin alloy comprises at least about 1.2% tin by weight.

22. The process according to claim 21, wherein said copper/tin alloy comprises less than about 10% tin by weight.

23. The process according to claim 22, wherein said copper/tin alloy ranges from about 2% to about 8% tin by weight.

24. The process according to claim 23, wherein said copper/tin alloy ranges from about 3% to about 6% tin by weight.

25. The process according to claim 18, wherein said copper/tin alloy comprises at least about 80% copper by weight.

26. The process according to claim 25, wherein said copper/tin alloy comprises at least about 90% copper by weight.

27. The process according to claim 18, wherein said copper/tin alloy comprises less than about 1% phosphorus by weight.

28. The process according to claim 18, wherein several copper/tin alloy layers (5, 6, 7) are deposited.

29. The process according to claims 18, wherein deposition of said layers (5, 6, 7) comprise the steps of:
(i) preheating the alloy zone;
(ii) supplying and melting copper/tin alloy via an electric arc; and
(iii) depositing said melted alloy in the preheated zone.

30. The process according to claim 29, wherein said preheating is carried out by using at least one electric arc.

31. The process according to claim 30, wherein said arc is generated by a TIG or a plasma welding torch.

32. The process according to claim 29, wherein said copper/tin alloy is supplied in the form of a wire.

33. The process according to claim 29, wherein said melting is generated by at least one MIG or TIG welding torch.

34. The process according to claim 18, wherein said phosphorus has a solubility limit that ranges from about 0.1% to about 3.5% by weight at the solidification temperature.

35. The process according to claim 18, wherein said matrix (2) comprises the steps of:
(i) providing support via a stack of several plates (11);
(ii) separating the plates by fins (12);
(iii) forming spacers between the plates (11); and
(iv) brazing the fins (12) to the plates (11),
wherein said matrix (2) and/or said workpiece (1) is a component of a fluid collecting and/or distributing container that forms part of a heat exchanger.

36. The process according to claim 35, wherein said workpiece (1) comprises copper or stainless steel.

37. The process according to claim 35, wherein manufacturing a brazed copper heat exchanger (10) comprises the steps of:
(i) welding at least one fluid collecting and distributing container (1), to a stack of plates (11);
(ii) forming spacers between the said plates (11) by the fins (12); and
(iii) supporting at least one matrix (2).

38. The process according to claim 37, wherein said collecting and distributing container (1) comprises copper.

39. A process for manufacturing a copper heat exchanger (10) comprising at least one collecting and distributing container (1) that comprises the steps of:
(i) welding said container (1) at 4 to a brazed (3) matrix (2);
(ii) supporting said matrix by a stack of several plates (11);
(iii) separating said plates (1 1) by fins (12); and
(iv) forming spacers between said plates (11).

40. The process according to claim 39, wherein said container (1) further comprises the steps of:
(v) depositing at least one copper/tin alloy layer (5,6,7) on the matrix (2); and
(vi) welding said container (1) to at least one said layer (5, 6, 7).

41. The process according to claim 40, wherein said copper/tin alloy comprises at least about 1% tin by weight.

42. The process according to claim 39, wherein said fluid collecting and distributing container (1), welded at 4, comprises copper or stainless steel.

43. The process according to claim 39, wherein a plant for separating fluids, particularly gas mixtures, utilizes at least one heat exchanger (10).

44. The process according to claim 43, wherein said plant utilized is a cryogenic air separation unit.

45. The process according to claim 43, wherein said process separates air.

46. The process according to claim 40, wherein said copper/tin alloy comprises tin in an amount selected from the group consisting of:
(a) at least about 1.0% tin by weight;
(b) at least about 1.05% tin by weight;
(c) at least about 1.2% tin by weight;
(d) less than about 10% tin by weight;
(e) about 2% to about 8% tin by weight; and
(f) about 3% to about 6% tin by weight.
